(19) United States
(12) Patent Application Publication
(10) Pub. No.: US 2014/0300091 A1
(43) Pub. Date: Oct. 9, 2014

(54) HIGH VOLTAGE COLOR INDICATED AIR BAGS

(71) Applicant: GM GLOBAL TECHNOLOGY OPERATIONS LLC, Detroit, MI (US)

(72) Inventors: SCOTT R. HERZ, WASHINGTON, MI (US); KEITH S. SCHULTZ, ROCHESTER, MI (US)

(73) Assignee: GM GLOBAL TECHNOLOGY OPERATIONS LLC, DETROIT, MI (US)

(21) Appl. No.: 13/856,676

(22) Filed: Apr. 4, 2013

(51) Int. Cl. B60R 21/013

(52) U.S. Cl. CPC B60R 21/013
USPC 280/735; 29/428

(57) ABSTRACT

An airbag system upon deployment indicates the type of power system in a vehicle in which the airbag system is contained in. The airbag system includes an airbag inflator, a crash sensor in communication with the airbag inflator, and an airbag. The airbag includes a flexible fabric cushion that has an exposed surface after the airbag is inflated by the airbag inflator. The exposed surface has an indicator that shows the type of power system within the vehicle.

### TECHNICAL FIELD

The invention relates to an airbag with enhanced safety features for alternative energy vehicles.

### BACKGROUND

Alternative energy vehicles are becoming more popular as further technological advances are made. Currently, alternative energy vehicles include electric, hybrid electric, fuel cell power systems (hydrogen), Compressed Natural Gas (CNG), and Liquefied Petroleum Gas (LPG). Although the possible dangers associated with gasoline and diesel fuels in vehicle collisions are well known, the alternative energy systems are less familiar to first responders thereby requiring special training. Moreover, the increasing variability in vehicle design presents rescuers with uncertainty as to which power system is being encountered in an emergency situation.

Electric, hybrid electric, and fuel cell vehicles present the risk of possible electrical shock for first responders due to the presence of high voltage batteries and other components. It is, therefore, of paramount importance that such rescuers immediately determine the type of power system when responding to an emergency situation such as a vehicle collision. Typically, the general appearance is insufficient for a determination of a vehicle's power system. For example, automobile manufacturers typically produce similar models for conventional and alternative energy vehicles. Some automobile manufacturers provide exterior badging on the vehicle that identifies the power system contained therein. However, in many instances such external indicators are not sufficient in that they tend to be somewhat small in size so as not to detract from the aesthetics of the vehicle. Moreover, after a collision, such an external marker might be obscured or hidden to first responders. Additionally, these markers may be intentionally removed or fall off over time.

Fuel cell vehicles provide an additional possible hazard for first responders. These vehicles use a gaseous fuel such as molecular hydrogen and methane which present potential fire hazards of a different nature than gasoline and diesel power systems. Therefore, it is also imperative in collisions involving fuel cell vehicles for the first responders to quickly determine if a vehicle includes a fuel cell power train.

Accordingly, there is a need for improved materials and methodologies for alerting first responders to the type of power system in a vehicle.

### SUMMARY

In at least one aspect, the present invention solves one or more problems of the prior art by providing an airbag system which, upon deployment, indicates the type of power system in a vehicle in which the airbag system is contained in. The airbag system includes an airbag inflator, a crash sensor in communication with the airbag inflator, and an airbag. The airbag includes a flexible fabric cushion that has an exposed surface after the airbag is inflated by the airbag inflator.

In another embodiment, an airbag system for a vehicle indicating the vehicle's power system is provided. The airbag system includes an airbag inflator, a crash sensor in communication with the airbag inflator, and an airbag. The airbag includes a flexible fabric cushion that is inflated by the airbag inflator. The exposed surface has an indicator that shows the type of power system within the vehicle. The airbag system further includes a non-white colored powder that imparts a non-white color to the airbag upon deployment of the airbag.

In another embodiment, a method of installing the airbag systems set forth above in a vehicle is provided. The method includes a step of manufacturing a plurality of automotive vehicle having different power systems as is typically done by the major automotive companies. An airbag system as set forth above is installed in each vehicle.

### BRIEF DESCRIPTION OF THE DRAWINGS

Exemplary embodiments of the present invention will become more fully understood from the detailed description and the accompanying drawings, wherein:

FIG. 1A provides a schematic illustration of an airbag system which has not been deployed with a visual indicator that a high voltage energy power system is contained in the vehicle;

FIG. 1B provides a schematic illustration of a deployed airbag system with a visual indicator that a high voltage energy power system is contained in the vehicle;

FIG. 2 provides a schematic illustration of a vehicle having a system for indicating the type of power system contained therein;

FIG. 3 provides a schematic illustration of a vehicle after a collision with a prior art airbag system;

FIG. 4 provides a schematic illustration of a vehicle after a collision with one variation of an airbag system indicating the power system contained therein;

FIG. 5 provides a schematic illustration of a vehicle after a collision with another variation of an airbag system indicating the power system contained therein;

FIG. 6A provides a perspective view of an airbag system having a dispersible powder; and

FIG. 6B provides an illustration of the airbag system of FIG. 6A after deployment with the powder having been dispersed in a vehicle interior.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

The term “dominant wavelength” as used herein refers to the wavelength of monochromatic light that gives the same perception of hue as a polychromatic light mixture. The dominant wavelength may be determined from CIE (International Commission on Illumination) coordinate space as a straight line from the point of an illuminant (e.g. white light, sun light, etc.) to the color in question in CIE coordinate space extrapolated to the perimeter of the coordinate space. The extrapolation is the dominant wavelength. In CIE coordinate space, white light or the “white point” is given an (x, y) value of (0.333, 0.333). Values of dominant wavelength herein are with respect to the white point or a white light source.

The term “average visible specular reflection” as used herein means the percent of an incident visible light beam that is specularly (i.e., non-diffusely) reflected by a surface.

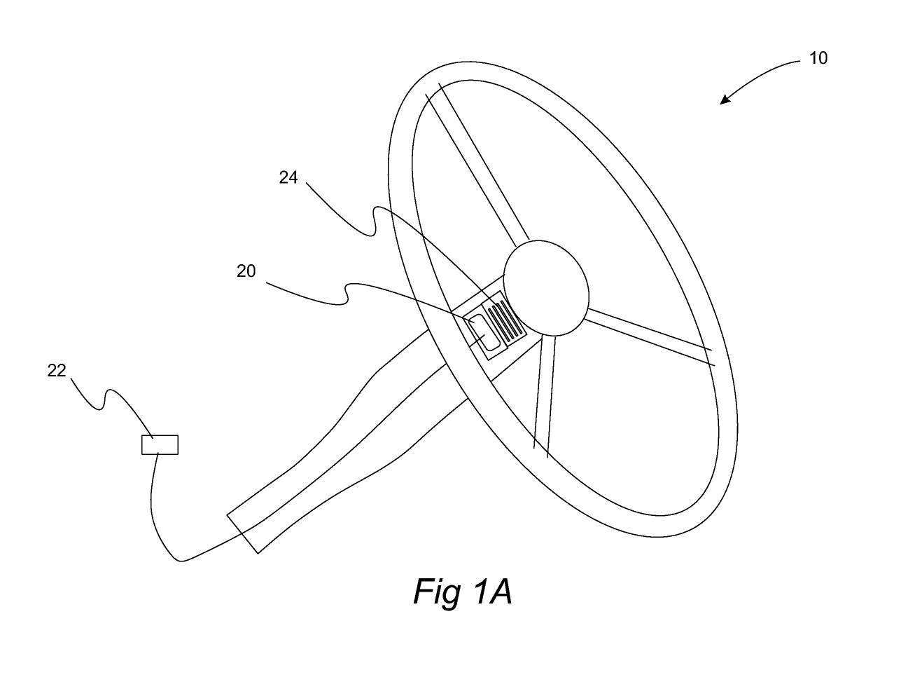

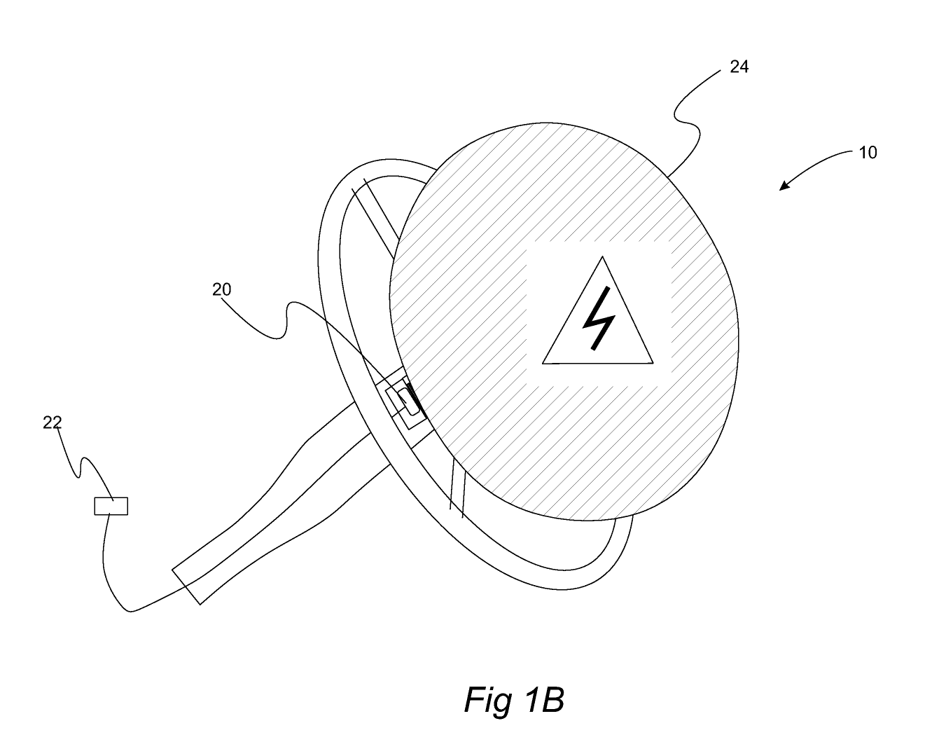

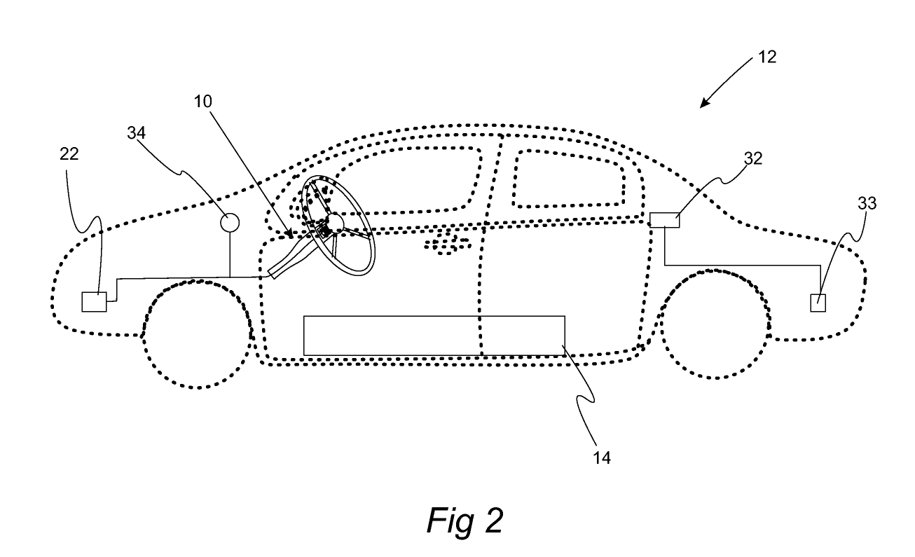

With reference to FIGS. 1A, 1B, and 2, schematic illustrations of an airbag system indicating the type of power system contained in a vehicle are provided. Airbag system 10 is installed in vehicle 12 which has power system 14. Airbag system 10 includes airbag inflator 20, crash sensor 22, and airbag 24. Crash sensor 22 is in communication (i.e., electrical communication) with airbag inflator 20. Airbag 24 includes a flexible fabric cushion 26 (i.e., the inflatable bag) that has exposed surface 28 after the airbag 24 is inflated by the airbag inflator 20. Exposed surface 28 includes indicator 30 that shows the type of power system 14 within the vehicle. Advantageously, the present embodiment provides first responders and other rescue workers with information about the type of power system within the vehicle after a crash. For example, the variation in FIG. 1B provides a visual indication that a high voltage power system is contained within vehicle 12. In this example, the visual indication is the coloring of exposed surface 28 (e.g., orange) and the presence of a “lightning bolt.”

The present variation is useful for providing rescuers information about any type of vehicle power system. Examples of such power systems include, but are not limited to, gasoline, diesel fuel, biodiesel, high voltage electric, hybrid electric, fuel cell, CNG, LPG, etc. Electric and hybrid electric vehicles pose a risk of electrocution while fuel cells using fuels such as hydrogen pose a risk of electrocution, fire or explosion. The ability of rescue workers to quickly ascertain the type of power system allows proper rescue procedures to be implemented and disasters such as electrocution and/or explosion to be avoided.

As set forth above, one type of indicator used in airbag system 10 is a visual indicator. In particular, exposed surface 28 presents a non-white color that indicates the type of power system in the vehicle under consideration. The non-white color is imparted onto exposed surface 28 by dying the airbag fabric or by painting. In one variation, the dye or paint used to impart the color is a fluorescent dye or paint. In a refinement, the non-white color has a dominant wavelength from 560 to 650 nanometers with respect to the white point. In another refinement, the non-white color has a dominant wavelength from 575 to 590 nanometers with respect to the white point. This latter example provides an orange color which in other applications is associated with high voltage components. Therefore, an exposed airbag surface having a dominant wavelength from 575 to 590 nanometers with respect to the white point is useful for high voltage power systems such as those found in electric vehicles and hybrid electric vehicles.

In another variation, exposed surface 28 is dyed or painted with an infrared fluorescent paint thereby providing rescuers the ability to observe the airbags at night with a suitable light source (ultraviolet light) or other suitable optical device. In this variation, a pattern (e.g., a lightning bolt or other pattern) may be presented by exposed surface 28 indicating the type of power system. Suitable infrared paints are commercially available from Nightmarker® located in Troy, New York.

Another type of visual indicator uses a symbolic representation of the type of power system. For example, an icon-like image of a “lightning bolt” is used to represent that the vehicle power system includes high voltage components. Symbolic representations are advantageously combined with other visual indicators such as a non-white color that is also linked to a particular type of power system.

In another refinement, the visual indicator is such that the exposed surface presents a reflective region that indicates the type of power system. Typically, the reflective region has an average visible specular reflection of greater than 10 percent. In another refinement, the reflective region has an average visible specular reflection of greater than 20 percent. In still another refinement, the reflective region has an average visible specular reflection of greater than 30 percent. In a further refinement, the reflective region is arranged into a reflective pattern (e.g., the icons set forth above) that indicates the type of power system.

With reference to FIG. 2, a variation of the airbag system includes an audio signal generator 32. The audio signal generator emits an audio signal upon a vehicle collision. In some variations, the audio signal generator is set to emit the audio signal even in collisions that would not generally cause the airbags to deploy (e.g., rear collisions via sensor 33). In a refinement, the audio signal includes a sound pattern (e.g., chirping) indicative of the type of power system. Also depicted in FIG. 2 is alarm light 34 which may provide a visible light signal indicating the time of power train in the event of an emergency situation (e.g., collision). In the light signal indicates the type of power system either by flashing a pattern or by the color of the light.

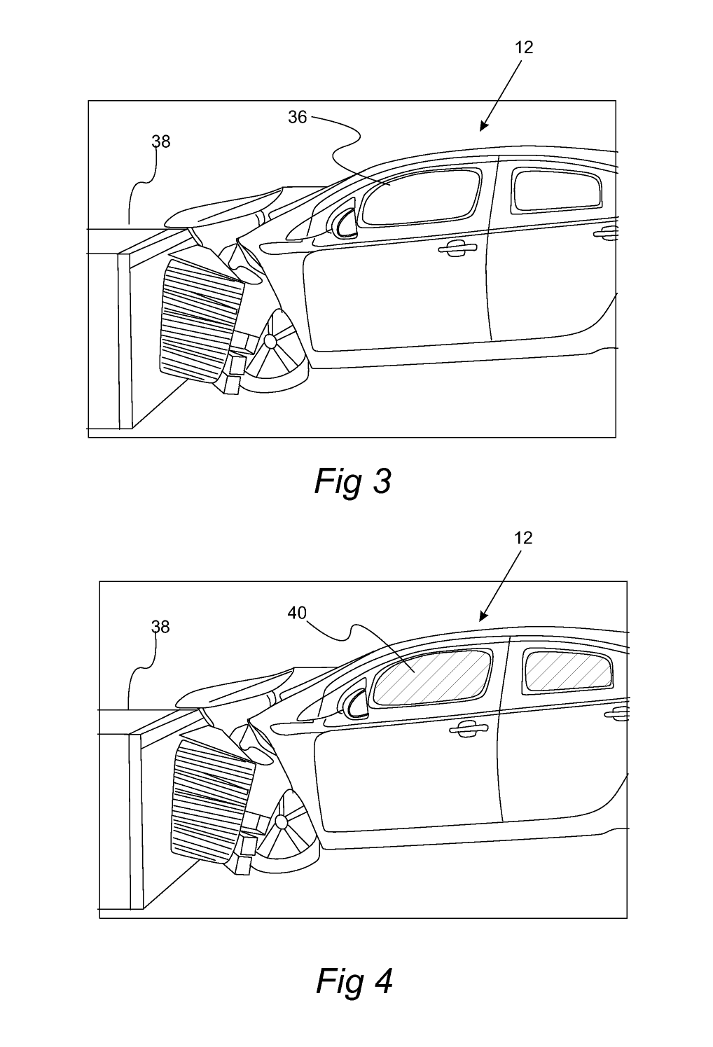

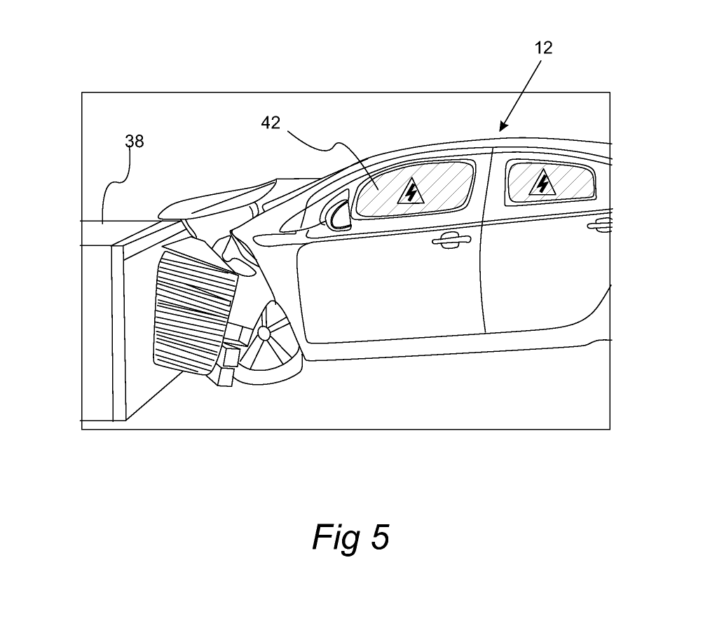

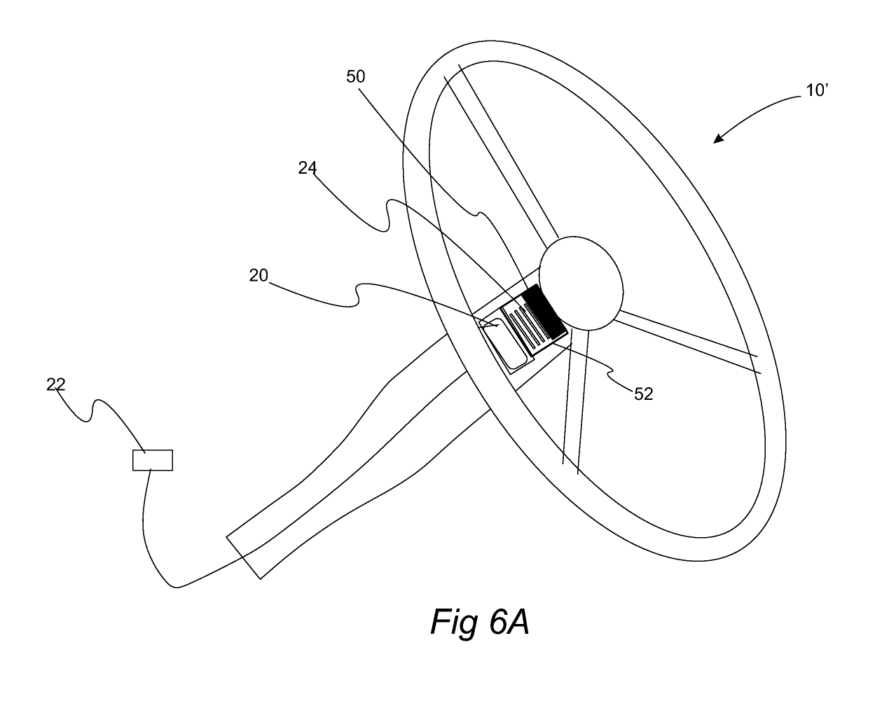

With reference to FIGS. 3, 4, and 5, schematic illustrations of deployed airbags systems after a collision are provided. FIG. 3 provides a schematic illustration of a vehicle after a collision with a prior art airbag system. In the prior art airbag system, deployed side airbag 36 does not provide any indication of the vehicle power system after vehicle 12 has collided with barrier 38. FIG. 4 provides a schematic illustration of a vehicle after a collision with an airbag having an exposed surface with a color that is linked to the type of power system therein. After a collision of vehicle 12 into barrier 38, the deployed side airbag 40 provides a clearly visible warning color to first responders that high voltage equipment is contained in the vehicle. Similarly, FIG. 5 provides a schematic illustration of a vehicle after a collision with an airbag having an exposed surface with an indicating color and a symbol that is linked to the type of power system therein. After a collision of vehicle 12 into barrier 38, the deployed side airbag 42 provides a clearly visible warning color and icon to first responders that high voltage equipment and/or alternative fuel type is contained in the vehicle.

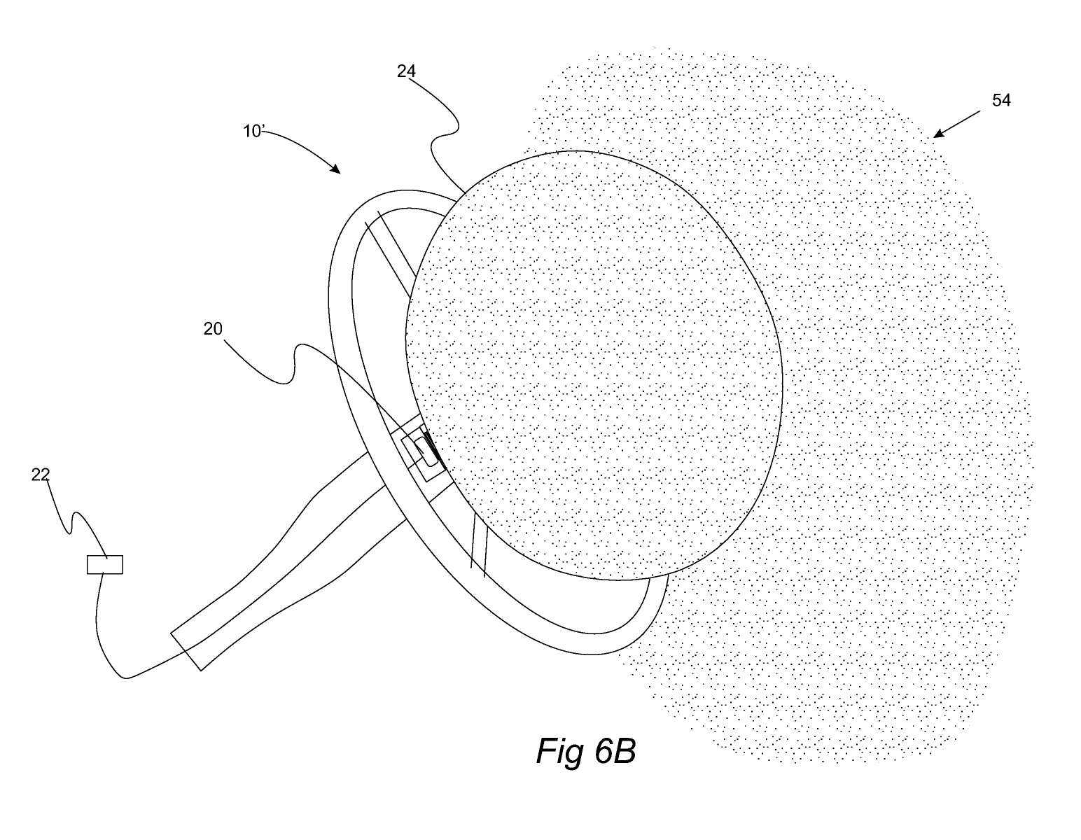

With reference to FIGS. 6A and 6B, schematic illustrations of another embodiment of an airbag system indicating the type of power system contained in a vehicle are provided. FIG. 6A provides a perspective view an airbag system having a dispersible powder while FIG. 6B illustrates the airbag system after deployment with the powder having been dispersed in a vehicle interior. Airbag system 10′ is installed in vehicle 12 which has power system 14. Airbag system 10′ includes airbag inflator 20, crash sensor 22, and airbag 24. Crash sensor 22 is in communication (i.e., electrical communication) with airbag inflator 20. Airbag 24 includes a flexible fabric cushion 26 (i.e., the inflatable bag) that is inflated by the airbag inflator 20. In this embodiment, airbag system 10′ includes colored powder 50 within airbag compartment 52 which imparts a non-white color to the airbag after deployment. Moreover, in some variations the powder is dispersed after a collision in which airbag 24 is deployed as indicated by dispersed powder 54. Advantageously, the present embodiment provides first responders and other rescue workers with information about the type of power system within the vehicle after a crash via the color of the airbag and/or the dispersed powder 52.

Still referring to FIGS. 6A and 6B, the colored powder 50 has a non-white color that indicates the type of power system in the vehicle under consideration. In a refinement, colored powder 50 has a dominant wavelength from 560 to 650 nanometers with respect to the white point. In another refinement, the colored powder 50 has a dominant wavelength from 575 to 590 nanometers with respect to the white point. This latter example provides an orange color which is advantageously associated with high voltage power systems.

In another refinement, colored powder 50 has an average visible specular reflection of greater than 10 percent. In yet another refinement, colored powder 50 has an average visible specular reflection of greater than 20 percent. In still another refinement, colored powder 50 has an average visible specular reflection of greater than 20 percent.

It should be appreciated that a typical automotive manufacturer produces a plurality of vehicles that often having different power systems. The automotive manufacturer will assign a particular airbag system with the appropriate indicator for the power system of each vehicle as set forth above. The airbag system is then installed in the vehicle. In order for the airbag systems set forth above to achieve the maximum benefit, the appropriate governmental agencies are informed and potentially an industry wide standard adopted.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An airbag system for a vehicle, the airbag system comprising:
an airbag inflator;
a crash sensor in communication with the airbag inflator; and
an airbag including a flexible fabric cushion, the flexible fabric cushion having an exposed surface after the airbag is inflated by the airbag inflator, the exposed surface having an indicator indicating a type of power system within the vehicle.

2. The airbag system of claim 1 wherein the power system is a high voltage electric power system.

3. The airbag system of claim 1 wherein the power system is a hybrid electric power system.

4. The airbag system of claim 1 wherein the power system is a fuel cell power system.

5. The airbag system of claim 1 wherein the indicator is a visible indicator.

6. The airbag system of claim 5 wherein the exposed surface presents a non-white color that indicates the type of power system.

7. The airbag system of claim 6 wherein the non-white color has a dominant wavelength of 560 to 650 nanometers with respect to a white point.

8. The airbag system of claim 6 wherein the non-white color has a dominant wavelength of 575 to 590 nanometers with respect to a white point.

9. The airbag system of claim 5 wherein the exposed surface presents a symbolic representation of the type of power system.

10. The airbag system of claim 5 wherein the exposed surface presents a reflective region that indicates the type of power system.

11. The airbag system of claim 10 wherein the reflective region has an average visible specular reflection of greater than 10 percent.

12. The airbag system of claim 10 wherein the reflective region has an average visible specular reflection of greater than 20 percent.

13. The airbag system of claim 10 wherein the reflective region is arranged into a reflective pattern that indicates the type of power system.

14. The airbag system of claim 1 further comprising an audio signal generator, the audio signal generator emitting an audio signal upon a vehicle collision.

15. The airbag system of claim 14 wherein the audio signal includes a sound pattern indicative of the type of power system.

16. The airbag system of claim 1 further including a visible light indicator for providing a signal indicating the type of power system.

17. A method of installing airbag systems in a vehicle, the method comprising:
a) manufacturing a plurality of automotive vehicles;
b) installing an airbag system in each vehicle, the airbag system including:
an airbag inflator;
a crash sensor in communication with the airbag inflator; and
an airbag including a flexible fabric cushion, the flexible fabric cushion having an exposed surface after the airbag is inflated by the airbag inflator, the exposed surface having an indicator indicating a type of power system within each vehicle in the plurality of automotive vehicles.

18. An airbag system for a vehicle, the airbag system comprising:
an airbag inflator;
a crash sensor in communication with the airbag inflator; and
an airbag including a flexible fabric cushion, the flexible fabric cushion being inflated by the airbag inflator; and
a non-white colored powder that provides a non-white color to the airbag.

19. The airbag system of claim 18 wherein the non-white colored powder has a color with a dominant wavelength of 560 to 650 nanometers with respect to a white point.

20. The airbag system of claim 17 wherein the non-white colored powder has a color with a dominant wavelength of 575 to 590 nanometers with respect to a white point.
